(19) United States
(12) Patent Application Publication
(10) Pub. No.: US 2025/0026109 A1
(43) Pub. Date: Jan. 23, 2025

(54) GLAZING UNIT FOR HEAD UP DISPLAY

(71) Applicant: AGC GLASS EUROPE, Louvain-la-Neuve (BE)

(72) Inventors: Xavier LALOYAUX, Gosselies (BE); Patrick AYOUB, Louvain-La-Neuve (BE)

(73) Assignee: AGC GLASS EUROPE, Louvain-la-Neuve (BE)

(21) Appl. No.: 18/711,412

(22) PCT Filed: Nov. 15, 2022
(86) PCT No.: PCT/EP2022/081953

§ 371 Date: May 17, 2024

(30) Foreign Application Priority Data
Dec. 15, 2021 (EP) 21214932.2

(51) Int. Cl. B32B 17/10

(52) U.S. Cl. CPC B32B 17/10458; B32B 17/10348; B32B 17/10541; B32B 17/10568; B32B 17/10651; B32B 2255/20; B32B 2307/416; B32B 2307/42; B32B 2307/7376

(57) ABSTRACT

A glazing unit having at least a first area and a second area, including an outer pane having a first surface and a second surface, and an inner pane having a first surface and a second surface, both panes bonded by an interlayer providing contact between the first surface of the inner pane and the second surface of the outer pane, where the first area is a display area having a light transmittance <30%, the display area being provided with a primary p-polarized light reflective coating, and to a head up display (HUD) using the glazing unit.

### FIELD OF THE INVENTION

The present invention relates to a glazing unit, and to a head up display (HUD) using said glazing unit.

### BACKGROUND OF THE INVENTION

Head up displays (HUD) find increasing uses in modern cars, displaying information to the driver of a vehicle while driving, and in some instances also to passengers. Information include traffic information, directions, speed, temperatures, vehicle conditions and so on.

A HUD typically comprises a pane used as display area and a projector used to project the information to be displayed on the display area. Optical devices such as waveplates, mirrors and so on may be provided according to the mounting of the HUD on the particular vehicle.

A vehicle includes those vehicles useful for transportation on road, in air, in and on water, in particular cars, busses, tramways, trains, ships, aircraft, spacecraft, space stations and other motor vehicles.

WO2021122848A1 relates to a HUD system comprising a. a light source projecting p-polarized light towards a glazing, b. said glazing comprising an outer sheet of glass having a first surface and a second surface, and an inner sheet of glass having a first surface and a second surface, wherein the second surface of the inner sheet of glass comprises a first coating, both sheets bonded by at least one sheet of interlayer material, characterized in that said first coating comprises at least one high refractive index layer having a thickness of from 50 to 100 nm, and at least one low refractive index layer having a thickness of from 70 to 160 nm, wherein the least one high refractive index layer comprises at least one of an oxide of Zr, Nb, Sn; a mixed oxide of Ti, Zr, Nb, Si, Sb, Sn, Zn, In; a nitride of Si, Zr; a mixed nitride of Si, Zr.

Co-pending application EP N° 21177439.3 relates to a coated substrate comprising a transparent substrate provided with a p-polarized light reflective coating, to a laminated glazing and a head up display (HUD) system comprising said coated substrate. The coating is positioned on the laminated glazing in the viewing area, said viewing area having a TL≥70%. That is, the display area is in the angle of view of the driver.

Several drawbacks are associated with the use of transparent panes as display area, such as for example, the windshield of a car. In some instances, the interference of exterior light on the information displayed may create loss of perception by the driver, such that the information is no longer clearly visible. In other instances, the coating present on the interior side of the windshield (P4) may display unsuitable colors, negatively impacting the aesthetics as observed from the outside. In further instances, the coating present on the interior side of the windshield may also enhance the presence of fingermarks as observed from the outside, providing for a bad perception. Last but not least, the major drawback being that of double images created by the reflection of light passing through the first air/glass interface (P1).

Several attempts to solve these issues were made, by providing for a display area on opaque or semi-opaque display area in the field of transparent view of the driver/observer.

Regulation No. 43 of the United Nations Economic Commission for Europe (UN/ECE) (ECE-R43) provides for “Uniform Conditions for the Approval of Safety Glazing Materials and Their Installation in Vehicles”. In the scope of said regulation, an opaque obscuration is defined as any area of the glazing preventing light transmission, including any screen-printed area, whether solid or dot-printed, but excluding any shade band. While shade band is defined as any area of the glazing with a reduced light transmittance, excluding any opaque obscuration.

Typical glazing units comprise a blackband or obscuration band as is customary for glazing units which have to be mounted on buildings or vehicles. Such obscuration band typically serves to ensure integrity of the adhesive lying under the glazing when it is mounted in the body opening by bonding, forming a screen against solar radiation, including ultraviolet radiation. In automobile windows, the enamel coatings may also serve to mask the electrical and other connection components located in the periphery of the internal side of the glazing and so improve the external appearance of the vehicle.

An example of obscuration band may be provided by an enamel coating typically applied on a portion of the surface of a glazing, for example in the periphery, that is, at a maximum of 25 cm from the outer edge of the glazing, or in segmented portions, as required by the final use and the final design of the enameled glazing and of the vehicle or building. An example of shading band may be applied in the upper border of a windshield to reduce incoming sun rays from disturbing the driver or occupants.

DE102016124987A1 relates to a windshield for a motor vehicle having a viewing area and a display area. The display area is arranged in a lower area of the windshield, and has a lower light transmission than the viewing area of the windshield. The display area is screen printed to reduce light transmission.

WO2021/185705A1 relates to a windscreen for a vehicle, in particular a motor vehicle, with a peripheral edge region, the peripheral edge region containing a black print. The windscreen has at least one separate dark display region, which is separated and distinct from the black print in the edge region, the display region being a film laminated onto the windscreen.

US2009/0295681A1 relates to a virtual image system for windshields that permits an image source to reflect off the windshield so that a virtual image, free of ghost image, is visible to the driver. Either a matte black material is applied to a windshield glass pane at any of the outer glass pane windshield surfaces 1 or 2, or at the inner glass pane windshield surface 3, or else a black glossy sheet is disposed at windshield surface 4 upon the windshield frit, whereby the virtual image is provided for any image source having real image rays incident at windshield surface 4.

WO2021/175608A1 relates to a windscreen display system for a motor vehicle having a head-up display device, having a first display region of a windscreen in the viewing area, and a second display region (window root area) below the first display area.

There remains need for a display area for glazing units for HUD systems which provide for good light reflection of information data, without compromising on driving safety.

The applicant has discovered, surprisingly, that a glazing unit having a display area having a light transmittance ≤30% provided with a p-polarized light reflective coating is efficient at reflecting information data projected from a light source projecting at least 50% p-polarized light, outside of the driving field of view of a driver.

### SUMMARY OF THE INVENTION

It is an object of the present invention to provide for glazing unit having at least a first area and a second area, comprising
a. an outer pane having a first surface and a second surface, and
b. an inner pane having a first surface and a second surface,
c. both panes bonded by at least one sheet of interlayer material providing contact between the first surface of the inner pane and the second surface of the outer pane,
d, wherein the first area is a display area having a light transmittance <30%, said display area being provided with a primary p-polarized light reflective coating.

The present invention further includes a method to provide for said glazing unit, and its use in a HUD system.

### BRIEF DESCRIPTION OF THE DRAWINGS

FIGS. 1 to 5 are schematic views of glazing units according to the present invention.

FIG. 6 is a view of glazing units when considered for windshields.

FIG. 7 is a schematic view of the position of the glazing unit and projector in a HUD per the present invention.

### DETAILED DESCRIPTION OF THE INVENTION

The glazing unit comprises an outer pane having a first surface and a second surface, and an inner pane having a first surface and a second surface, both panes bonded by at least one sheet of interlayer material providing contact between the first surface of the inner pane and the second surface of the outer pane.

The present glazing unit thus comprises an outer pane having a first surface (P1) and a second surface (P2), and an inner pane having a first surface (P3) and a second surface (P4), forming a laminated glazing. The outer pane of the laminated glazing is that pane in contact with the exterior of the vehicle or building. The inner pane is that pane in contact with the inner space of the vehicle, compartment or building, that is, in contact with the surrounding atmosphere.

The glazing unit typically will serve to separate an interior from an external environment, that is, for defining an outdoor from an indoor compartment or room.

The outer and inner panes may be independently selected from transparent substrates, such as glass substrate, or plastic substrate comprising or consisting of poly(methyl meth)acrylate (PMMA), polycarbonates, polyethyleneterephthalate (PET), polyolefins, polyvinyl chloride (PVC), or mixtures thereof.

In the scope of the present invention, transparency of a substrate or material is considered when light transmittance (TL) in the visible region (380-780 nm) is superior or equal to 30%, alternatively superior to 40%, alternatively superior to 50%.

In the scope of the present invention, opacity is defined by a light transmittance less than 5%, preferably less than 1%, equal to zero %. In the scope of the present invention, shading is defined by a light transmittance of from 5 to less than 30%.

Advantageously, the outer and inner panes are glass substrates.

The glass may be of any type, such as conventional float glass or flat glass, and may be of any composition having any optical properties, e.g., any value of visible transmission above 10%, ultraviolet transmission, infrared transmission, and/or total solar energy transmission.

The glass may be a soda-lime, a borosilicate, a leaded glass, or an alumino-silicate glass. The glass may be regular a clear, colored or extra-clear (i.e. lower Fe content and higher transmittance) glass substrate. Further examples of glass substrates include clear, green, bronze, or blue-green glass substrates.

The composition of the glass is not crucial for the purpose of the present invention, provided said glass sheet is appropriate for transportation or architectural applications. The glass may be clear glass, extra-clear glass or colored glass, comprising one or more component(s)/colorant(s) in an appropriate amount as a function of the effect desired. Colored glass include grey, green or blue float glass. In some circumstances, colored glass may be advantageous to provide for appropriate and desired color of the final glazing, within the limitations of applicable legislation.

A particularly suited colored glass may be green glass, as it offers superior aesthetics as observed from the outside of a vehicle. Green glass may for example be a soda-lime glass with iron oxide in the form of Fe₂O₃ in amounts ranging of from 0.3 to 1.0 wt %. Another type of suitable glass may for example be a soda-lime glass with iron oxide in the form of Fe₂O₃ in amounts ranging of from 0.002-0.06 wt % and chromium content in the form of Cr₂O₃ in amounts ranging of from 0.0001-0.06 wt %.

The outer and inner panes may independently have a thickness ranging from 0.5 mm to about 15 mm, alternatively from 1 mm to about 10 mm, alternatively from 1 mm to about 8 mm, alternatively from 1 mm to about 6 mm. In transportation applications, the panes may have a thickness ranging of from 1 to 8 mm, while they may also be thinner or thicker in construction applications, like ultrathin glass from 0.5 to 1 mm, or thicker glass, from 8 to 12 mm, in addition to the thickness of from 1 to 8 mm.

Both panes may have the same thickness, for example 0.5 mm, or 0.8 mm, or 1.2 mm, or 1.6 mm, or 2.1 mm, or 3 mm. Such symmetrical construction in glass thickness allows for ease of process and conventional sizing of the laminating process.

Both panes may also have different thicknesses, providing for asymmetrical laminated glazings, for example pane 1=0.5 mm and pane 2=2.1 mm, or pane 1=0.8 mm and pane 2=2.1 mm, or pane 1=0.5 mm and pane 2=1.6 mm, pane 1=0.8 mm and pane 2=1.6 mm, or pane 1=1.6 mm and pane 2=2.1 mm. Such asymmetrical constructions in glass thickness allow for flexibility in curvature, and/or in weight management and/or flexibility in light/solar modulation.

The glass may be flat or totally or partially curved to correctly fit with the particular design of the glass support, as the shape requires for the application.

The glass may be annealed, tempered or heat strengthened glass.

The inner and outer panes of glass need not have the same compositions. That is, one of the panes may be a colored glass pane, while the other pane may be a clear glass pane. This allows for flexibility in light and energy management from the exterior to the interior.

The interlayer provides for the contact between the first surface of the inner pane (P3) and the second surface of the outer pane (P2).

The interlayer typically comprises thermoplastic material, for example, polyvinyl butyral (PVB), ethylene vinyl acetate (EVA), polyurethane (PU), polyethylene terephthalate (PET), polycarbonate, or multiple layers thereof. A single sheet of interlayer material may have a thickness of from 0.1 to 0.5 mm.

In most instances, several sheets of interlayer material are adjoined together to form the interlayer between the two panes. The total thickness of said interlayer typically ranges of from 0.3 to 0.9 mm.

The interlayer may have a uniform thickness throughout its surface between the two panes, or may have a non-uniform thickness throughout its surface, that is, the interlayer may be a “wedge” interlayer. This provides for some more advantage on the HUD system, in specific situations where other light sources are used in conjunction with the present system.

The interlayer may comprise light absorber or any other light interfering polymers, if the end use so requires, provided the initial purpose of the present invention is not jeopardized.

In specific embodiments, compatible with other embodiments of the present invention, the interlayer may be a wedge interlayer. Such a wedge interlayer may have a varying thickness over the surface of the glazing unit, such that the distance between the adjoined panes varies from one situation point from another. Such wedge interlayer may find usefulness when the present system is used in conjunction with other systems which require the use of wedge interlayers.

The present glazing unit has at least a first area and a second area. The first area is thus a display area having a light transmittance <30% (III. A, 2°), alternatively <20%, alternatively <10%, alternatively <5%, preferably <1%. In some instances, the display area may have a TL=0% denoting total opacity.

The second area, on the other hand, is a viewing area, and has a visible light transmittance ≥70% (III. A, 2°). The light transmittance and reflectance, are typically measured according to ISO9050, with Illuminant A, at an angle of 2°.

Norm ECE-R43 specifies the technical requirements that the central field of view of an automobile must have a high light transmission (typically greater than 70%). Said central field of vision is in particular that field of vision which is referred to by the person skilled in the art as field of vision B, field of vision B or zone B, here the second area or viewing area.

In the scope of the present invention, the terms “display area” and “projection area” may be used interchangeably, when the first display area is considered.

When a glazing pane having a light transmittance >70% is used as display area, there may be interferences from the air/outer pane interface, which may degrade the quality of the reflected image, as discussed above. On the contrary, when the display area is an area having a light transmittance <30%, the interference of the air/outer pane interface is reduced, and as such, the image is sharp and ghosting effect if reduced or eliminated. When the display area is an area having a light transmittance <1%, the interference of the air/outer pane interface is eliminated, and as such, the image is sharper and free of ghost.

The light transmittance of less than 30% of the display area may be achieved by different opacifying means, selectively arranged in said display area. The selected opacifying means are intended to either shade and/or opacify, such that TL is <30% or less, as discussed above.

The opacifying means of the display area may be at least one selected from
a dark print;
a dark insert;
a dark patch;
or combinations thereof.

When a dark print is used as opacifying means, the dark print may be selected from enamel, paint, and/or ink. The dark print may be applied on either one of P1, P2, P3 of the laminated glazing.

Among dark prints, enamel is preferably used to opacify the projection area, when deposited on either one of P1, P2, P3 of the laminated glazing. Typical enamel compositions typically comprise a glass frit, pigments and other additives in a medium. Additives include adhesion promoters, crystalline seed materials, reducing agents, conductive metals (e.g. silver particles), rheological modifiers, flow aids, adhesion promoters, stabilizers, etc.

The main advantage of an enamel opacifying means is that total opacity may be achieved, that is TL may be <5%, preferably <1%, most preferably equal to 0%. An advantage of an enamel when used as opacifying means, is that the same enamel may be used to define the display area, and the obscuration band, if such band is present.

The surface of the display area may be along the width and height of the obscuration band, or may be restricted to only a portion of said obscuration band. In such instances, the preferred obscuration material may be an enamel, in P2 or P3. This option is easily put to practice by the customary means of applying the obscuration band, and provides for the optimal opacity by the appropriate choice of a black enamel having a color such that L*<6, a*=0±3, b*=0±3 (in the CIELAB colorspace).

The surface of an obscuration band of a glazing unit may range of from 0.5 to 25% of the surface of the glazing unit, for example in automotive or transportation applications.

Examples of paints include vinyl paints, acrylic paints and the like. They may also be chosen to provide for shading, such that TL is <30%. When an ink or paint is used, opacity may also be achieved, with TL<5% or even less. These have the advantage that they may easily be printed by inkjet printing.

When a dark insert is used, such insert may be selected from polyvinyl butyral (PVB), ethylene vinyl acetate (EVA), polyurethane (PU), polyethylene terephthalate (PET), polycarbonate, polyvinylchloride, mylar, or mixtures thereof.

When a dark insert is used, it may be selectively arranged in the projection area by typical design solutions within the bonding interlayer, so as to provide for a display area. Such insert may be referred to as an obscuration insert. The dark insert may thus be inserted within a selected area coinciding with the projection area, within the interlayer serving as adhesive bonding between the laminated panes. Indeed, the interlayer may comprise several sheets of interlayer material, one of which may comprise the dark insert such that it is selectively arranged to define the first display area of the glazing pane and selected to provide for a final light transmittance less than 30%. Dark inserts exist and are known to the skilled person in the art. In the scope of the present invention, a dark insert is considered as having a light transmittance <30%, preferably <10%, more preferably <5%, even more preferably <1%, most preferably equal to 0%.

In such instances, the light transmittance of the display area may thus be tuned to potentially fit other uses of the display area, when total opacity may not be required. That is when shading is sufficient, with a TL ranging of from 5% to less than 30%.

In the scope of the present invention, when a dark print and/or a dark insert is used as opacifying means, the primary p-polarized light reflective coating may be present on the second surface of the inner pane (surface P4). The display area of the glazing unit having a light transmittance <30%, is thus provided with a primary p-polarized light reflective coating on the second surface of the inner pane, according to the invention. This has the advantage that there is no surface effect on the second surface of the inner pane, towards the interior and that the surface of the glazing unit remains flat and even (with no relief).

In the scope of the present invention, when a dark patch is used, it may be provided as a laminated patch, arranged on the second surface of the inner pane. The patch having a first surface and a second surface, is typically a piece of material selected from glass, or plastic comprising or consisting of poly(methyl meth)acrylate (PMMA), polycarbonates, polyethyleneterephthalate (PET), polyolefins, polyvinyl chloride (PVC), or mixtures thereof. The first surface of the patch (surface P5) may be laminated to the second surface of the inner pane by at least one of the interlayer materials disclosed above, which may be clear or colored, according to the selected type of patch material.

The primary p-polarized light reflective coating may then be present on the second surface of the patch material (surface P6). This has the advantage that smaller pieces of material may be coated and applied on the glazing unit, such that the display area of the glazing unit having a light transmittance <30%, is provided with a p-polarized light reflective coating, according to the invention.

Preferred dark patches may comprise a piece of clear glass, or extra-clear glass, or low iron glass in combination with a dark interlayer, or may comprise a piece of dark glass with an interlayer with no particular light transmittance requirement.

The glass patch sheet should be as thin as possible. When a glass patch is used, it is preferred that the patch glass sheet has a thickness of not more than 2 mm, preferably not more than 1 mm.

In the first instance, when a piece of clear glass, or extra-clear glass, or low iron glass is used in combination with a dark interlayer, said interlayer may have a light transmittance <30% such as those described above, or preferably <10%, more preferably <5%, even more preferably <1%, most preferably equal to 0%.

In the second instance, when a piece of dark glass is used in combination with an interlayer, there is no specific requirement for the interlayer, while the glass may have a light transmittance <30%. The dark glass may be a colored soda-lime, borosilicate, leaded glass, or alumino-silicate glass. Such a dark glass may have a visible light transmittance (for a 4 mm thick sheet)<20%, alternatively <15%, alternatively <12%, alternatively <10%, alternatively <8%, alternatively <6%, alternatively <5%, alternatively <2%, alternatively <1%, alternatively=0% for complete opacity.

Such a dark glass may however have transmission for IR rays (1050 nm or 1550 nm)>80%. This may have the added advantage that the dark glass patch may serve a Lidar functionality, in addition to being the display area, when the glass and interlayer are so selected that they are transmissive to infrared rays (800 to 2000 nm), while having a visible light transmittance as required for the purpose of the present invention.

In some embodiments, multiple opacifying means may be combined, such as a dark patch superimposed over an obscuration band, or else.

The opacified display area of the present glazing unit is provided with a primary p-polarized light reflective coating. In the scope of the present invention, a primary p-polarized light reflective coating is intended to describe a coating or stack of thin layers which is capable of reflecting incident p-polarized light, at any angle of incidence.

This primary p-polarized light reflective coating is advantageously applied over the display area to increase the amount of reflection of incident p-polarized light, such as may be used in head up displays, as will be discussed below. By improving the reflection of p-polarized light, the present primary coating may allow for the use of light projector projecting at least 50% p-polarized light and still achieve a sharp and well-defined image. Such projectors are readily available at accessible cost. The projector may also project 100% p-polarized light, if the use so requires.

In the scope of the present invention, the primary p-polarized light reflective coating is applied on the surface of the inner pane facing the inner space of the vehicle or building, that is to say the primary p-polarized light reflective coating is into direct contact with the surrounding atmosphere.

The primary p-polarized light reflective coating is considered a nonconductive coating, that is, its sheet resistance may be >100 Ohm/square. This provides for the advantage that the present coated substrate comprising a transparent substrate provided with a primary p-polarized light reflective coating does not require decoating to be compatible for use in advanced driver-assistance systems (ADAS) or compatible with electromagnetic communication thorough the glass, that is, the primary p-polarized light reflective coating is compatible with communication, sensor or camera windows ensuring the transmission of electromagnetic radiation.

In the scope of the invention, the primary p-polarized reflective coating may typically comprise at least one sequence of layers of high refractive index layers/low refractive index layers, or high/low sequence. The high/low sequence may occur more than once, that is, the sequence may be repeated at least 2 times, up to 3 or 4 times.

In the scope of the present invention, the primary p-polarized reflective coatings may preferably be a magnetron sputtered p-polarized reflective coating, having the advantage of being easily processed, easily adaptable to the selected function, and cost efficient.

In the scope of the present invention, the thickness of the coatings and thin layers are geometrical thicknesses expressed in nm, unless indicated otherwise.

In the scope of the present invention, the terms “below”, “underneath”, “under” indicate the relative position of a layer vis a vis a next layer, within the layer sequence starting from the substrate. In the scope of the present invention, the terms “above”, “upper”, “on top”, “on” indicate the relative position of a layer vis a vis a next layer, within the layer sequence starting from the substrate.

In the scope of the present invention, a high refractive index is typically ≥1.8, alternatively >1.9, alternatively >2.0, alternatively >2.1, at a wavelength of 550 nm.

The high refractive index layers may be selected from oxides of Zn, Sn, Ti, Nb, Zr, Ni, In, Al, Ce, W, Mo, Sb, Bi and mixtures thereof; nitrides or oxynitrides of Si, Al, Zr, B, Y, Ce, La; and mixtures thereof.

In the scope of the present invention, a low refractive index is typically ≤1.7, alternatively ≤1.6, at a wavelength of 550 nm.

The low refractive index layers may be selected from silicon oxide, silicon oxycarbide, aluminum oxide, mixed silicon aluminum oxide, mixed silicon zirconium oxide (with n<1.7), aluminum doped zinc oxide, magnesium fluoride, or mixtures thereof.

The refractive index at a wavelength of 550 nm of the high refractive index materials is typically higher than the refractive index of the low refractive index materials. The refractive indices of the high and low refractive index materials may differ by a value of at least 0.1, preferably by a value of at least 0.2, more preferably by a value of at least 0.25.

A first suitable primary p-polarized reflective coating comprises, in sequence starting from the substrate surface,
at least one high refractive index layer having a thickness of from 50 to 100 nm and
at least one low refractive index layer having a thickness of from 70 to 160 nm, wherein the least one high refractive index layer comprises at least one of
   an oxide of Zr, Nb, Sn;
   a mixed oxide of Ti, Zr, Nb, Si, Sb, Sn, Zn, In;
   a nitride of Si, Zr;
   a mixed nitride of Si, Zr (with n >1.7).

A layer in the present first suitable primary p-polarized reflective coating may comprise more than one sub-layer.

Such a first suitable primary p-polarized reflective coating is already efficient having p-polarized light reflection >15%, with a low complexity of design, and is resistant to thermal treatment.

A second particularly suitable primary p-polarized reflective coating comprises, in sequence starting from the substrate surface,
a. optionally
   i. a first layer, composed of one or more high refractive index sub-layers, the first coating having a thickness of from 1 to 100 nm, and
   ii. a second layer, composed of one or more low refractive index sub-layers, the second layer having a thickness of from 1 to 220 nm, and
b. a third layer, composed of one or more high refractive index sub-layers, the third layer having a thickness of from 40 to 150 nm, and
c. a fourth layer, composed of one or more low refractive index sub-layers, the fourth layer having a thickness of from 40 to 200 nm, and
   further comprising at least one first layer of absorbent material, said at least one first layer of absorbent material having a thickness of from 0.2 to 15 nm, and said absorbent material having an average refractive index n above 1 and an average extinction coefficient k above 0.1, with the averages n and k calculated over the values at the wavelengths of 450 nm, 550 nm and 650 nm.

This second particularly suitable p-polarized light reflecting coating optionally comprises a first layer, composed of one or more sub-layers of high refractive index materials and a second layer, composed of one or more sub-layers of low refractive index material. This optional pair of layers provide improved reflection of p-polarized light, but at a higher production cost.

The first layer, when present, is composed of one or more sub-layers of high refractive index material, independently selected from the materials described above. When present, the first layer may have a thickness of from 1 to 100 nm, alternatively of from 2 to 80 nm, alternatively of from 4 to 65 nm, alternatively of from 4 to 15 nm.

The second layer, when present, is composed of one or more sub-layers of low refractive index material, independently selected from the materials described above. When present, the second layer may have a thickness of from 1 to 220 nm, alternatively of from 2 to 210 nm, alternatively of from 4 to 200 nm, alternatively of from 100 to 200 nm.

The third layer is composed of one or more sub-layers of high refractive index material, independently selected from the materials described above. The third layer may have a thickness of from 40 to 150 nm, alternatively of from 45 to 135 nm, alternatively of from 50 to 125 nm.

The fourth layer is composed of one or more sub-layers of low refractive index material, independently selected from the materials described above. The fourth layer may have a thickness of from 400 to 200 nm, alternatively of from 45 to 160 nm, alternatively of from 50 to 150 nm.

Each of the optional first, optional second, third or fourth layer may thus independently consist of one single layer, or may comprise two or more sub-layers.

The high refractive index materials of the second particularly suitable primary p-polarized reflective coating may be selected from
an oxide of Zr, Nb, Sn, Zn or Ti;
a mixed oxide of two or more of Ti, Zr, Nb, Si, Sb, Sn, Zn, In;
a nitride of Si, Zr, Al, B;
a mixed nitride of two or more of Si, Zr, Al, B.

The high refractive index materials of the second particularly suitable primary p-polarized reflective coating may preferably be selected from mixed titanium zirconium oxide, mixed titanium silicon oxide, mixed niobium zirconium oxide, mixed silicon zirconium nitride, aluminum doped silicon nitride, zirconium oxide, mixed indium tin oxide, mixed zinc rich aluminum oxide, mixed antimony tin oxide, mixed titanium zinc oxide, mixed zinc tin oxide.

In some occurrences, an undercoat may be present in contact with the surface of the pane surface. Such an undercoat is distinct from any of the first or second or third or fourth layer of the second particularly suitable primary p-polarized reflective coating. Such an undercoat does not provide any optical impact to the p-polarized light reflective coating, but may function as a diffusion barrier from the substrate or as a seed layer to the subsequent layers. In preferred embodiments, the undercoat may present particularly in absence of the first and second layers.

By “absorbent material” is meant a material which absorbs a part of the visible radiation.

The absorbent material may be characterized by an average refractive index n above 1 and an average extinction coefficient k above 0.1, with the averages n and k calculated over the values of n and k at 3 wavelengths, namely 450 nm, 550 nm and 650 nm.

The average n is thus calculated using the values of refractive index of the material at the 3 wavelengths of 450 nm, 550 nm and 650 nm. The average k is calculated using the values of extinction coefficient of the material at the 3 wavelengths of 450 nm, 550 nm and 650 nm.

The skilled person in the art is familiar with the n and k optical parameters. Thin film optical simulation software such as Thin Film Center or CODE, have their own databases but also provide a reliable tool for person skilled in the art to fit n and k optical models of thin films deposited with known physical thickness and a characterized substrate.

The at least one first layer of absorbent material may be selected from NiCr, W, Nb, Zr, Ta, Pd, Si, Ti, or alloys based on Ni and/or Cr and/or W or alloys based on Cr and Zr, or on W and Zr or Cr, or on W and Ta, optionally including an additional element selected from Ti, Nb, Ta, Ni and Sn; or from TiN, CrN, WN, NbN, TaN, ZrN, NiCrN, or NiCrWN, or a mixture of these nitrides.

The nitrides may also be partially oxidized provided absorption is maintained with k above 0.1 over the range between 450 nm and 650 nm.

The absorbent material layer may be provided with at least one barrier layer above and/or below said absorbent layer. Such a barrier layer may have a geometric thickness comprised between 5 and 50 nm. Examples of such barrier layers include silicon nitride or aluminum doped zinc oxide or titanium oxide or mixed titanium zirconium oxide.

That is, in some instances, the at least one first layer of absorbent material may comprise a layer of NiCr or NiCrW provided with at least one barrier (below or above) of silicon nitride, or be flanked by (below and above) a first dielectric coating formed essentially of silicon nitride and a second dielectric coating formed essentially of silicon nitride, each independently having a geometric thickness comprised between 5 and 50 nm; or the at least one first layer of absorbent material may comprise a layer of Pd (palladium) flanked by a first dielectric coating formed essentially of aluminum doped zinc oxide and a second dielectric coating formed essentially of aluminum doped zinc oxide, each independently having a geometric thickness comprised between 5 and 50 nm. Such a layer of absorbent material allows for optimal reflection of p-polarized light with optimal light absorption.

The at least one first layer of absorbent material may preferably be selected from NiCr, W, Nb, Pd, Si, Ti, or alloys based on Ni and/or Cr and/or W; or from TIN, CrN, WN, NbN, TaN, ZrN, NiCrN, or NiCrWN, or a mixture of these nitrides.

The at least one first layer of absorbent material may more preferably be selected from NiCr, W, Pd, Si, Ti, or alloys based on Ni and/or Cr and/or W; or from TIN, CrN, WN, NiCrN, or NiCrWN, or a mixture of these nitrides.

For the sake of information, the average refractive index n and average extinction coefficient k, for various absorbent materials and for silver are presented in Table 1. This average is calculated over 3 values of wavelength, namely at 450, 550 and 650 nm. An average refractive index n<1 is indicative of a material which does not suit as absorbent material. Silver, gold, copper, aluminum having an average n<1, are thus not suitable.

TABLE 1

| Materials | Average n | Average k |
|---|---|---|
| Pd | 3.13 | 1.73 |
| NiCr | 2.50 | 3.70 |
| NiCrW | 3.34 | 3.84 |
| NiCrWN | 2.56 | 2.20 |
| Si | 3.95 | 1.16 |
| Ag | 0.09 | 3.52 |

Although not mandatory, heat resistance of the absorbent material may be useful, that is, it preferably remains essentially unchanged upon a heat treatment above a temperature of 400° C.

The absorbent material does not comprise silver. A material such as silver does not provide the necessary enhancement of the reflection of the p-polarized light due to its low refractive index n below 1, and does not allow for the positioning of the p-polarized reflective coating on a surface of the glazing pane facing the interior of the compartment (surface P4).

The at least one first layer of absorbent material may have a thickness of from 0.2 to 15 nm, alternatively of from 0.5 to 15 nm, alternatively of from 2 to 12 nm.

The at least one first layer of absorbent material may be
either inserted between at least two adjacent coatings of the said first, second, third or fourth layer, or
inserted within at least one of the said first, second, third or fourth layer.

Such a second suitable primary p-polarized reflective coating is very efficient having p-polarized light reflection >20%, is resistant to thermal treatment and may be tuned for efficiency without sacrificing on light transmittance.

The particulars of this second suitable primary p-polarized reflective coating in the scope of the present invention, is that it does not mandatorily need to have a light transmittance >70%, when used in a laminated glazing of 2 clear glass sheets of 2.1 mm with a clear interlayer of 0.76 mm, since it is not intended to be transparent to the view. The advantage of such a second suitable primary p-polarized coating is that the reflectance of p-polarized light may reach up to at least 20% p-polarized light reflection when positioned on a display area having TL<30%, while color neutrality need not be optimized.

In the scope of the present invention, the primary p-polarized reflective coating itself may have any light transmittance, that is, a light transmittance less than 90%, less than 70%, alternatively less than 65%, alternatively less than 60%, and greater than 30%, alternatively greater than 40%, when measured on a sheet of monolithic clear float glass of 2.1 mm.

As discussed above, the primary p-polarized light reflective coating is considered a nonconductive coating. This would not be possible if a silver layer would be considered as absorbent material.

The primary p-polarized light reflective coating is sufficiently durable and resistant to scratches, corrosion or damages, to be present in position P4 of a laminated system, facing the interior of a habitable or room. This would not be possible if a silver layer is present in the primary p-polarized light reflective coating.

In the scope of the present invention, the primary p-polarized light reflective coating is thus free of electroconductive layer based on silver, since the primary p-polarized light reflective coating has to be positioned towards the inner space of the vehicle or building and be resistant to scratches.

In certain embodiments, compatible with the above, the second area having a light transmittance >70%, or viewing area, may be provided with a p-polarized coating, which may be the same or different from the primary p-polarized coating, since it is critical that said viewing area satisfies the legal requirements for vehicle glazing with a TL≥70% (III. A, 2°). The present invention therefore refers to the first area having a TL<30% used as a display area, compatible with previous viewing area having a TL>70% used as display area.

In embodiments compatible with the above, the glazing unit may further comprise an infrared reflective (IR) coating comprising n infrared reflective (IR) functional layer based layer and n+1 dielectric layers, each IR reflective functional layer based layer being located between two dielectric layers, may optionally be provided between the outer pane and the inner pane of the laminated glazing. That is, an infrared reflective (IR) coating may be applied on at least one of the first surface of the inner pane (P3) or the second surface of the outer pane (P2) or embedded in the interlayer.

In the scope of the present invention, the relative positions of the layers within the IR coating do not necessarily imply direct contact. That is, some intermediate layer may be provided between a first and a second layer. In some instances, a layer may actually be composed of several multiple individual layers (or sublayers).

In some instances, the relative position may imply direct contact, and will be specified.

The IR reflective metallic functional layer (or functional layer) may be made of silver, or aluminum or alloys thereof, eventually doped with less than 15 wt % with platinum, palladium or gold. The functional layer may have a thickness of from 5 to 22 nm, alternatively of from 7 to 20 nm, alternatively of from 8 to 18 nm. The thickness range of the functional layer will influence the conductivity, the emissivity, the anti-solar function and the light transmission of the second coating.

The dielectric layers may typically comprise oxides, nitrides, oxynitrides or oxycarbides of Zn, Sn, Ti, Zr, In, Al, Bi, Ta, Mg, Nb, Y, Ga, Sb, Mg, Si and mixtures thereof. These materials may be optionally doped, where examples of dopants include aluminum, zirconium, or mixtures thereof. The dopant or mixture of dopants may be present in an amount up to 15 wt %. Typical examples of dielectric materials include, but are not limited to, silicon based oxides, silicon based nitrides, zinc oxides, tin oxides, mixed zinc-tin oxides, silicon nitrides, silicon oxynitrides, titanium oxides, aluminum oxides, zirconium oxides, niobium oxides, aluminum nitrides, bismuth oxides, mixed silicon-zirconium nitrides, and mixtures of at least two thereof, such as for example titanium-zirconium oxide.

The IR coating may comprise a seed layer underneath at least one functional layer, and/or the coating may comprise a barrier layer on at least one functional layer. A given functional layer may be provided with either a seed layer, or a barrier layer or both. A first functional layer may be provided with either one or both of seed and barrier layers, and a second functional layer may be provided with either one or both of seed and barrier layers and further so. These constructions are not mutually exclusive. The seed and/or barrier layers may have a thickness of from 0.1 to 35 nm, alternatively 0.5 to 25 nm, alternatively 0.5 to 15 nm, alternatively 0.5 to 10 nm.

The IR coating may also comprise a thin layer of sacrificial material having a thickness <15 nm, alternatively <9 nm, provided above and in contact with at least one functional layer, and which may be selected from the group comprising titanium, zinc, nickel, aluminum chrome and mixtures thereof.

The IR coating may optionally comprise a topcoat or top layer, as last layer, intended to protect the stack below it, from damage. Such top coat include oxides of Ti, Zr, Si, Al, or mixtures thereof; nitrides of Si, Al, or mixtures thereof; carbon-based layers (such as graphite or diamond-like carbon).

When embedded in the interlayer, the IR coating may be deposited on a plastic substrate, said plastic substrate then being inserted between the first surface of the inner pane and the second surface of the outer pane, within the interlayer (sandwiched by interlayer material on both sides), or in contact with one of first surface of the inner pane and the second surface of the outer pane on one side and in contact with the interlayer on the other side.

Examples of plastic substrates as IR coating support include poly(ethyleneterephthalate) (“PET”), poly(butyleneterephthalate), polyacrylates and methacrylates such as poly(methylmethacrylate) (“PMMA”), poly(methacrylate), and poly(ethylacrylate), copolymers such as poly(methylmethacrylate-co-ethylacrylate) and polycarbonates, in the form of thin sheets. The plastic substrates themselves are commercially available or can be prepared by various art-known processes.

IR coatings on glass or on plastic substrates are typically known in the art and will not be further described herein. Their advantages lie in the solar and heat management, while allowing for the provision of heatable glazing units.

In the scope of the present invention, the IR reflective coating is preferably absent from the display area, such as to not interfere with the functioning of the display area of the glazing unit. If the IR reflective coating is located on the first surface of the inner pane (P3), it may preferably be removed from the area of the display area, so as to not compromise the functioning of said display area, removal may take place by decoating. If the IR reflective coating is located on the second surface of the outer pane (P2), it may remain present, provided the opacifying means is situated between the IR reflective coating and the display area, such as the dark print or dark insert, otherwise, it may preferably be removed.

The IR reflective coating may also serve as heating element, to provide for heating of the glazing unit.

In embodiments compatible with the above, optionally, at least the second area of the glazing unit is provided with an anti-fingerprint coating and/or easy to clean coating. Such an anti-fingerprint coating may prove useful to avoid interferences of light from the viewing area. The fingerprints will be less visible from the outside, and provide for improved aesthetics. The first area may also be provided with the same anti-fingerprint coating and/or easy to clean coating, although there is anyway no visibility from the outside such at aesthetics is anyway not reduced.

Examples of anti-fingerprint coatings include fluorinated polyethers, silanes, fluoro-silanes, siloxanes, fluorinated siloxanes, phosphonates, fluoro-organic compounds, perfluorocarbon-containing materials, and the like. These anti-fingerprint coatings are known in the art.

The present invention also provides for a method to provide for a glazing unit, comprising the following steps:
1) Providing for an outer pane having a first surface and a second surface,
2) Providing for an inner pane having a first surface and a second surface, which second surface has at least a first area and a second area,
3) Providing for a primary p-polarized light reflective coating on at least the first area of the second surface of the inner pane,
4) Providing for an opacifying means in at least the area of the second surface provided with the primary p-polarized light reflective coating such that said area has a light transmittance <30%,
5) Bonding the two panes by an interlayer providing contact between the first surface of the inner pane and the second surface of the outer pane.

The deposition methods of the primary p-polarized light reflective coating include chemical vapor deposition (CVD), Plasma enhanced chemical vapor deposition (PECVD), Physical vapor deposition (PVD), magnetron sputtering, wet coating, etc. Preferably, the primary p-polarized light reflective coating is a magnetron sputtered coating.

The selective deposition of the primary p-polarized light reflective coating on the selected first area may be effected by selective deposition and/or by masking.

The opacifying means are provided according to the means selected.

A dark print may be deposited as typical for enamel, paint and/or ink, by screen printing, roller coating, spraying, curtain coating, decal application, inkjet or the like, optionally in presence of masking or shape/shadow defining elements.

The enamel coating will typically be applied on the surface of a pane facing the thermoplastic interlayer, that is, in positions P2 or P3.

The enamel coating for the obscuration band is typically applied on a portion of the surface of a glazing, for example in the periphery, that is, at a maximum of 25 cm from the outer edge of the glazing, or in segmented portions, as required by the final use and the final design of the enameled glazing and of the vehicle or building. In some instances, the enamel coating for the obscuration band may be applied on the surface of the glass sheet facing the interior of the vehicle, that is, position P4, for example for assisting in the adhesion of the vehicle window to the vehicle frame. In the scope of the present invention, it was found advantageous that, when positioned in P4, the primary p-polarized light reflective coating is compatible with such an enamel coating used to provide the compatibility with the adhesives typically used for adhesion of the window on a car body, or in an architectural window frame.

A dark insert may be placed within the bonding interlayer prior to the lamination step 5).

A dark patch may be laminated to the glazing unit after step 5), using conventional techniques to adhere such a dark patch to a glazing unit, by the bonding of the first surface of the patch (P5) to the second surface of the inner pane (P4). In such instances, the second surface of the patch (P6) is previously provided with the primary p-polarized light reflective coating by any method discussed above.

An infrared reflective coating may be deposited on either one of the first surface of the inner pane or on the second surface of the outer pane, or be provided in the glazing unit supported on a plastic sheet inserted within the bonding interlayer.

The deposition methods of the optional IR coating on the surface of a pane include chemical vapor deposition (CVD), Plasma enhanced chemical vapor deposition (PECVD), Physical vapor deposition (PVD), magnetron sputtering, wet coating, etc. Different layers of the respective coatings may be deposited using different techniques.

An anti-fingerprint coating, when present, may typically be applied by wet coating techniques such as dip coating, spray coating, spin coating, brush coating, among others.

In the scope of the present invention, the inner and outer panes may be subjected to a thermal treatment. In some case, it may be useful to mechanically reinforce the outer pane by a thermal treatment to improve its resistance to mechanical constraints.

The thermal treatments comprise heating the glazing to a temperature of at least 560° C. in air, for example between 560° C. and 700° C., in particular around 640° C. to 670° C., during around 3, 4, 6, 8, 10, 12 or even 15 minutes according to the heat-treatment type and the thickness of the glazing. The treatment may comprise a rapid cooling step after the heating step, to introduce a stress difference between the surfaces and the core of the glass so that in case of impact, the so-called tempered glass sheet will break safely in small pieces. If the cooling step is less strong, the glass will then simply be heat-strengthened and in any case offer a better mechanical resistance.

The inner and outer panes, and the interlayer of the present glazing unit are assembled by known techniques providing for laminated glazing, such as a lamination step for flat substrates, or a bending step for curved substrates, which bending step includes the steps of first bending the panes and second, laminating said bent panes.

The present invention also provides for a HUD system comprising
a. a glazing unit as disclosed herein, having at least a first area as a display area having a light transmittance <30% and a second area, and
b. a light source projecting at least 50% p-polarized light towards the first display area of the glazing unit, wherein the light projected by the light source is incident on and reflected from said first display area.

The light source typically provides for light projection towards the glazing. In the scope of the present invention, the light source specifically projects incident light on the display area having a light transmittance >30%.

The light source herein includes a polarizer such that the projected light may be at least 50% p-polarized light. This allows for the use of less stringent polarizers and for flexibility of the projected light, depending on situational conditions, such as the amount of natural light available, the weather or other external conditions. The advantage of having at least 50% p-polarized light, is that the system is compatible with standard sunglasses (generally p-polarized sunglasses).

In other instances, the light source may provide for 100% p-polarized light.

The projector may be adapted such that the intensity may be tuned to lower levels, since the contrast from the display area having a TL<30% will improve reflection due to reduced light transmission.

Light sources providing for light, be it p-polarized or s-polarized light or not polarized light, are typically known in the art and will not be described herein. Examples of projectors include LED, LCD, VF, OLED, and the like.

Typically, the projected light is incident to the display area of the glazing at an angle of 42 to 72 degrees, in the incident plane.

The display area may thus be a defined surface of the glazing pane, specifically designed to be out of the viewing line of a driver but in a near area of said viewing line such that it can be viewed without the driver losing sight of the road, in the case of a HUD or other driving assistance item. The display area may be arranged below, or on the side, or above the central field of view (field of view B per norm ECE-R43), but it should not protrude into said central field of view. It need not necessarily be in contact with the peripheral obscuration band, however, in preferred embodiments, the display area is located in at least a portion of the bottom obscuration band. Such a lower positioning allows for easy viewing access from a driver, with only eye movements and thus without any major loss of sight on the road.

The advantage of the present HUD is that the display area may be designed to remain close to the field of view of the driver, and/or designed to be viewable by a passenger or other occupant of the compartment. The increased reflection also allows for tunable projector according to the environmental conditions (more or less sun light, presence of sunglasses, or other conditions).

An advantage of the present HUD system configured with p-polarized light source, is that the (Rp-pol) may reach up to 20%, at an angle of incidence of said p-polarized light of 65°. Values of reflected p-polarized light may rise up to 23%, up to 26%, up to 30% or even up to 39% at an angle of incidence of 65°.

An additional advantage is that this display area may be compatible with existing HUD systems arranged in the second area, or viewing area having TL≥70%, where the transmission of the central field of view is not impaired by the p-polarized reflective coating.

The present glazing unit may be useful in transportation applications or architectural applications, where projection of images or light from a light source projecting at least 50% p-polarized light towards a display area having a light transmittance <30% may prove useful. Architectural applications include displays, windows, doors, partitions, shower panels, and the like. In such architectural applications, the projection of a sharp image on an opacified surface of a glazing unit separating an inner space form an outer space, may be convenient to allow for displaying room information, building information, entertainment material or the like, without interference from light from the outer space.

Transportation applications include those vehicles for transportation on road, in air, in and on water, in particular cars, busses, trains, ships, aircraft, spacecraft, space stations and other motor vehicles.

The present glazing unit may thus be a windshield, rear window, side window, sun roof, panoramic roof or any other window useful for a car, or any glazing for any other transportation device, where the projection of a sharp image on a display area having a light transmittance <30% may be useful. The information projected and reflected may include any traffic information, such as directions, navigation instructions or traffic density; or any vehicle status information, such as speed, temperature, tank filling, driving safety system; or entertainment matter, or the like. The field of display, under or on the side of the viewing area having a light transmittance ≥70%, allows for a sharp and defined image, without interference from the outside environment or light conditions. This has the advantage of reducing the hinderance of the driver's view.

In some embodiments, compatible with other embodiments of the invention, a second light source may be present in the HUD system and provide for a secondary image or information. The second light source may not be polarized or may be p-polarized or s-polarized, but would provide for an image the same or different from the first light source. In some instances, the image or information is different between the first and second light source. In some instances, augmented reality information may be projected by at least one of the light source, thanks to the wide field of view and/or field of projection provided by the glazing unit, having at least a first area and a second area.

The present invention also provides for the use of a glazing unit having at least a first area and a second area, comprising
a. an outer pane having a first surface and a second surface, and
b. an inner pane having a first surface and a second surface,
c. both panes bonded by an interlayer providing contact between the first surface of the inner pane and the second surface of the outer pane,
   wherein the first area is a display area having a light transmittance <30%, said display area being provided with a first p-polarized light reflective coating, in a HUD system comprising a p-polarized light source which projects light at an angle of incidence of 42 to 72° on the display area of the glazing unit, to reflect said p-polarized light.

Use of such a glazing unit having a display area having a light transmittance <30% in a HUD system allows for various advantages, over glazing units having only display areas having a light transmittance >70%. A first such advantage is that the p-polarized light reflective coating of the display area has less optical requirement for neutrality of color in reflection, while having optimized p-polarized light reflection (R p-pol).

Another advantage is that there is no disturbance in the driving field of view field of the driver, with the benefit of having the display area being easily arranged in the vicinity of said driving field of view. The display are may be localized under the field of view, in the root of the windshield, for example, or in a side pilar, or even in the upper region of the viewing area, or on the roof or a side window, such that the driver may focus on the road observation. These advantages may also be translated into architectural applications, where there is no movement implied, but the necessity of keeping a clear view in an area, and the necessity of having information projected and reflected effectively from another proximal display area. Together with the elimination of ghost images generated by the interference of the air/glass interface from the P1 surface, the present glazing unit also allows for an eliminated view on fingerprints on the P4 surface, when observed from an outside standpoint, for an improved aesthetics.

### FIGURES

Embodiments of the glazing unit, a HUD and its uses are provided with the present figures, illustrating several non-limiting options within the scope of the invention.

The various elements of the figures are not in scale.

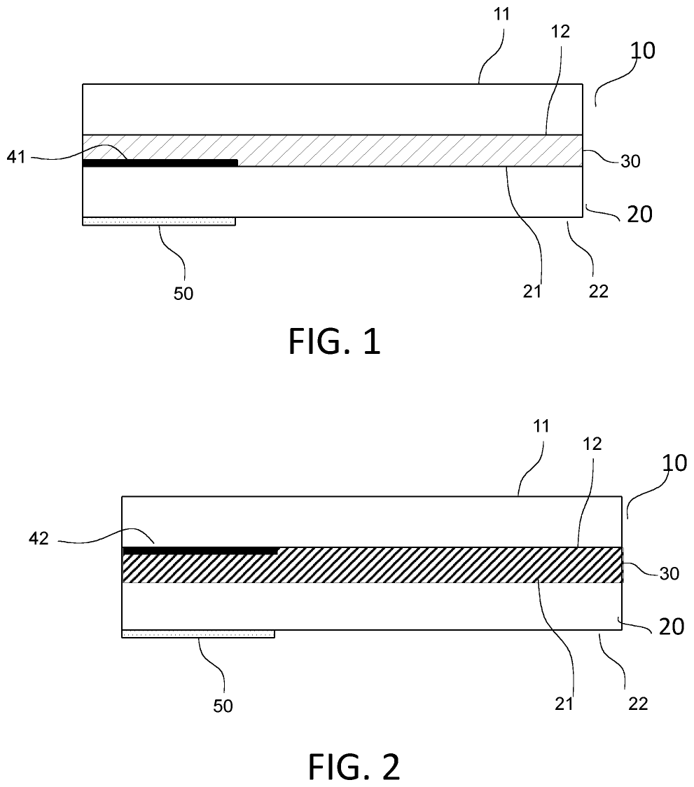

FIG. 1 represents a glazing unit having at least a first area and a second area, comprising
a. an outer pane (10) having a first surface (11) and a second surface (12), and
b. an inner pane (20) having a first surface (21) and a second surface (22),
c. both panes bonded by an interlayer (30) providing contact between the first surface (21) of the inner pane and the second surface (12) of the outer pane, wherein the first area is a display area having a light transmittance <30%, due to the dark print (41), applied on surface (21). The display area is provided with a primary p-polarized light reflective coating (50) on surface (22). The dark print may be selected from enamel, paint and/or ink, as discussed above. The dark print is not necessarily placed on the periphery, but should anyway be placed outside of the second area, here viewing area, as per the norm ECE-R43 and the general legal requirements for a TL≥70% for a viewing window such as a windshield.
   A layer of enamel (not shown) may be applied over and in contact with the primary p-polarized light reflective coating (50) to serve the adhesion of the glazing unit onto a support or frame or vehicle body.

FIG. 2 represents an alternative version of FIG. 1, wherein the dark print (42), is applied on surface (12) of the glazing unit. The dark print may be selected from enamel, paint and/or ink, as discussed above.

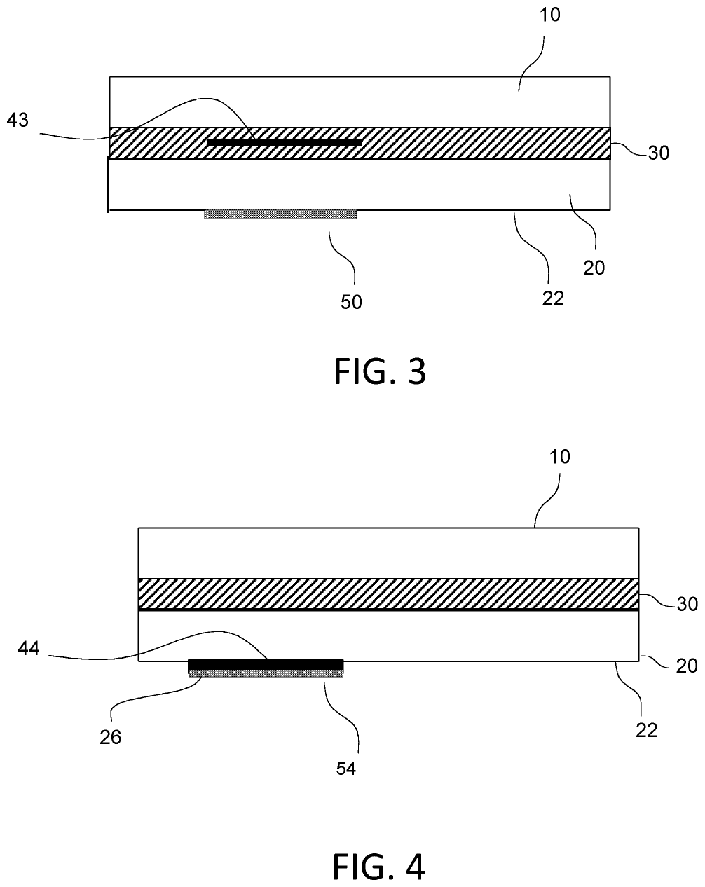

FIG. 3 represents a glazing unit having at least a first area and a second area, comprising
a. an outer pane (10) having a first surface and a second surface, and
b. an inner pane (20) having a first surface and a second surface,
c. both panes bonded by an interlayer (30) providing contact between the first surface of the inner pane and the second surface of the outer pane, wherein the first area is a display area having a light transmittance <30%, due to the dark insert (43), within interlayer (30). The display area is provided with a primary p-polarized light reflective coating (50) on surface (22). The dark insert may also be placed on the periphery if preferred, but it should remain outside of the second viewing area, as per the norm ECE-R43 and general legal requirements.

FIG. 4 represents a glazing unit having at least a first area and a second area, comprising
a. an outer pane (10) having a first surface and a second surface, and
b. an inner pane (20) having a first surface and a second surface,
c. both panes bonded by an interlayer (30) providing contact between the first surface of the inner pane and the second surface of the outer pane, wherein the first area is a display area having a light transmittance <30%. The display area is provided by a dark patch (44) as opacifying means, laminated to surface (22) of the inner pane (20), such that the primary p-polarized light reflective coating (54) is present on surface (26) of the dark patch. The dark patch may be a thin glass as discussed above, with a PVB interlayer to adhere to the inner glass—for reasons of simplicity, the thin glass and the interlayer are pictured as one single unit=dark patch (44).

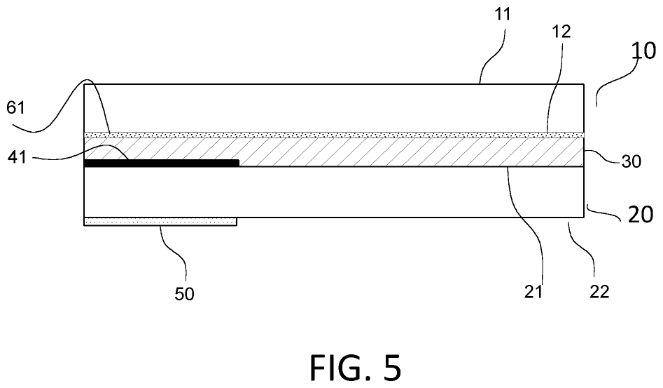

FIG. 5 is a further alternative of FIG. 1, wherein the glazing unit further comprises an infrared reflective layer (61) on second surface (12) of the outer pane.

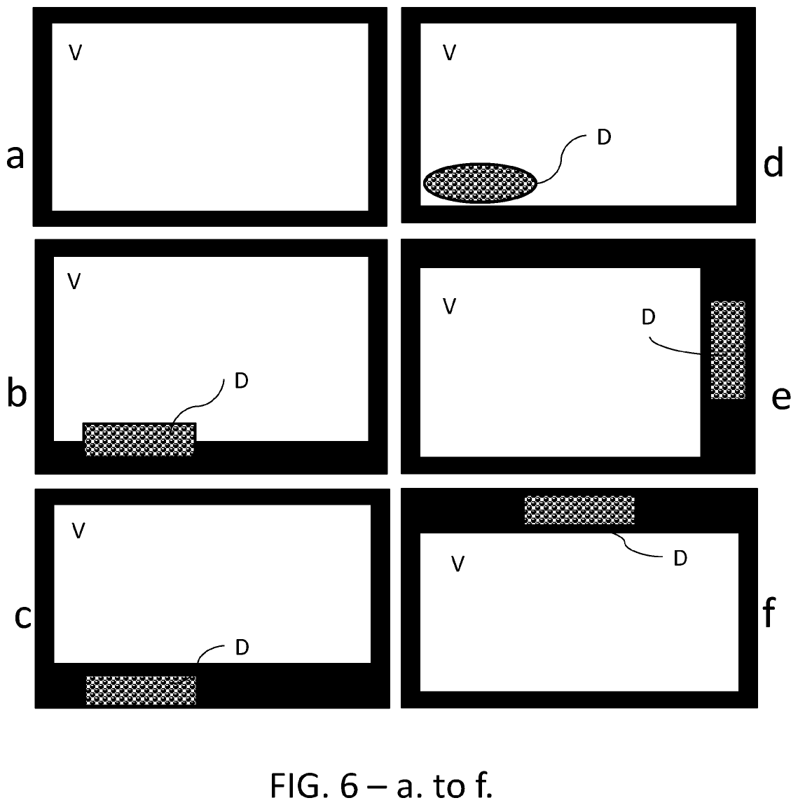

FIG. 6-a to f: A glazing unit may have a peripheral obscuration band, such as commonly described per norm ECE-R43. The peripheral area is typically opaque, with TL<1%. The center area is considered the viewing area (V-white area), which must satisfy a TL≥70% per the legal requirements also set out in norm ECE-R43.

Each of the gazing unit of FIGS. 6b to 6f is provided with a display area (D), either in partial overlap with the viewing area and the obscuration band (b), or in total overlap with the obscuration band in a lower position (c), or lateral position (e), or upper position (f). The display area may also be completely independent from the obscuration band (d), in a position where the legal requirements for vehicle windows are satisfied with regard to the viewing area having TL≥70%, such that the display area is not a hinderance to driving. Indeed, the obscuration band as illustrated in FIG. 6 is not a mandatory feature of the present invention, but is illustrated here to refer more easily to automotive windows, such as windshields. Said obscuration band may thus be omitted from the presently claimed glazing unit. The display area D may be provided by any of the different opacifying means disclosed above.

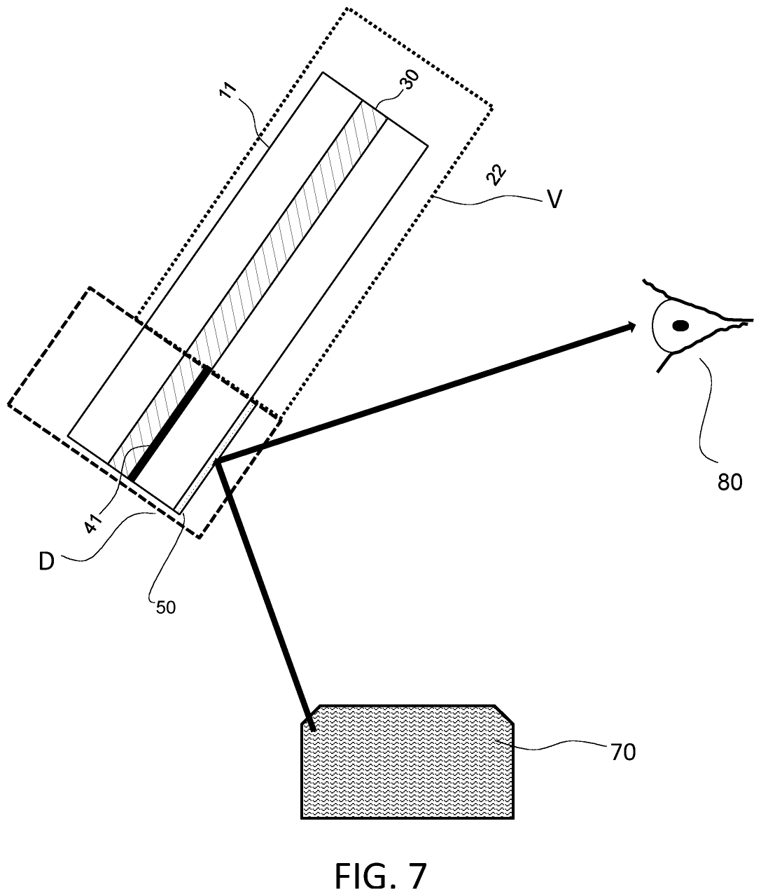

FIG. 7 represents a HUD system as claimed, comprising a projector (70), projecting at least 50% p-polarized light towards the display area (D) having a TL<30% of a glazing unit (as per FIG. 1), said display area (D) being lower than the field of view (V) of an observer or driver (80). The projected light is incident to the primary p-polarized light reflective coating, present on the interior side of the compartment occupied by the observer.

### EXAMPLES

Glass panes with a primary p-polarized light reflective coating were prepared or simulated by an optical modelling software in single sheet glazing, and afterwards set up in laminated form to form a glazing unit, such that said glazing unit could be evaluated for their optical parameters in view of specific light conditions.

Types and thicknesses of said glass panes, coatings details and test conditions will be provided hereafter. The light source was configured to emit normal light or p-polarized light 100%. Behavior of the glazing towards the incident light is presented in the following tables.

All optical parameters are given for illuminant D65, 2° for reflection or transmission levels and illuminant D65, 10° for color indexes (a* and b*).

All refractive indices are measured at a wavelength of 550 nm, unless otherwise indicated.

In the present examples, the clear glass was clear float glass, used with a thickness of 1.8 mm excepted when stated as a single sheet of 4 mm.

The green glass was a soda-lime glass with iron oxide in the form of Fe₂O₃ in amounts ranging of from 0.3 to 1.0 wt % and was used with a thickness of 1.8 mm.

Dielectric Materials:
TZO: Titanium oxide/Zirconium oxide in a ratio 55/45 wt %, having a refractive index of 2.19 (at 550 nm)
SiO₂: Silicon oxide, exhibiting a refractive index of 1.46 (at 550 nm)
SiN: Nitride of Silicon & Aluminum including Silicon/Aluminum ratio of 90/10 wt %, and having a refractive index of 2.03 (at 550 nm)
MgF₂: magnesium fluoride, having a refractive index of 1.38 (at 550 nm)
Nb₂O₅: niobium oxide, having a refractive index of 2.36 (at 550 nm) Absorbent (ABS) materials:
NiCr: Nickel-Chromium binary alloy with a ratio 80/20 wt %

Parameters measured concerning external reflection (Rv (out)) were as follows: (When a “p-pol” reference is associated with a parameter, it means the incident light used is p-polarized light. When there is no such indication, the light is mixed light-unpolarized.):
a) Illuminant A, 2°
   Tv (%)=transmission in the visible range
   Rv (out) (%)=external reflection in the visible range (380-780 nm) at a «standard» incidence angle of 8° (this information is provided herein although it will be hidden from the view when the glazing unit area is used in conjunction with the opacifying means to reach TL<30%)
   Rv (in) (%)=internal reflection in the visible range (380-780 nm) at a «standard» incidence angle of 8°
   Rp_pol65 (%)=interior reflection of p-polarized light in the visible range (380-780 nm) and at an incidence angle of 65°
   R65Y (in) (%)=interior reflection in the visible range (380-780 nm) at a «standard» incidence angle of 65°
   Rp_pol65 (%) (blue)=interior reflection of p-polarized light in the wavelength range of 450-500 nm
   Rp_pol65 (%) (green)=interior reflection of p-polarized light in the wavelength range of 500-550 nm
   Rp_pol65 (%) (red)=interior reflection of p-polarized light in the wavelength range of 630-680 nm
b) Illuminant D65, 10°
   Ta*=a* color index in transmission
   Tb*=b* color index in transmission
   RL*=L* color index for reflection inside at 8°
   R65L*=L* color index for reflection inside at 65°
   Ra*=a* color index for reflection inside at 8°
   R65a*=a* color index for reflection inside at 65°
   Rb*=b* color index for reflection inside at 8°
   R65b*=b* color index for reflection inside at 65°
   Rp_pol65-a=a* color index for reflection inside at 65 for p-polarized light
   Rp_pol65-b=b* color index for reflection inside at 65 for p-polarized light

Results generally indicate
transmission of visible light Tv (%) may be adapted to more or less than 70%
optical properties in interior reflection, such as Rp-pol at 65° may reach up to levels of 20 to 39%, for coatings having a TL<70% (in laminated glazing)

These results indicate the suitability of the present glazing unit in a HUD system as claimed, for any projected color, among blue, green or red.

### Examples 1 to 10

Examples 1 and 2 were prepared according to the description of the first suitable primary p-polarized light reflective coating, without any layer of absorbent material. Example 1 comprises one sequence of high refractive index layer/low refractive index layer, each being a single layer. Example 2 comprises one sequence of high refractive index layer/low refractive index layer, the high refractive index layer being a multilayer, and the low refractive index being a single layer.

Examples 3 to 10 were prepared according to the description of the second particularly suitable primary p-polarized light reflective coating, with a layer of absorbent material. Examples 3, 4 and 6 comprise two sequences of high refractive index layer/low refractive index layer, where the third layer comprises several high refractive index sub-layers. Examples 5, 7, 8, 9 and 10 comprise one sequence of high refractive index layer/low refractive index layer, with the high refractive index layer (third layer) being a multilayer comprising several high refractive index sub-layers.

The assembled glazing unit comprised two sheets of clear glass of 2.1 mm, laminated with a PVB layer of 0.76 mm. The opacifying means may be chosen among any of those discussed above.

Values for the layer thicknesses of the primary p-polarized light reflective coating are indicated in Table 2, together with the results of the measured parameters of the glazing unit in absence of opacifying means. Indeed, the presence of the opacifying means does not allow for measurements to be taken properly (due to the lack of light transmission).

The advantage of the primary p-polarized light reflective coating present on the display area of the present glazing unit is that it allows for reflection of p-polarized light. On the contrary, when the display area is not provided with a primary p-polarized light reflective coating, then there is zero reflection of the light, since said light is absorbed by the opacifying means. Specially, when a display area having a light transmittance <5% is not provided with a primary p-polarized light reflective coating, there is substantially no p-polarized light reflection.

TABLE 2

| Example | Example | Example | Example | Example | Example | Example | Example | Example | Example |
|---|---|---|---|---|---|---|---|---|---|
| 1 | 2 | 3 | 4 | 5 | 6 | 7 | 8 | 9 | 10 |

Material//Thickness (nm)

| | | | | | | | | | | |
|---|---|---|---|---|---|---|---|---|---|---|
| TZO | — | — | 16.49 | 10.65 | — | 33.56 | — | — | — | — |
| SiO₂ | — | — | 17.02 | 52.60 | — | 10.02 | — | — | — | — |
| TZO | 64.88 | 53.99 | 28.56 | 39.41 | 34.24 | 11.70 | 50.92 | 48.68 | 42.06 | 39.04 |
| SiN | — | 10.20 | 10.86 | 10.80 | 10.52 | 10.45 | 10.20 | 10.38 | 10.42 | 10.08 |
| Absorber | — | — | 11.39 | 11.42 | 16.55 | 5.33 | 5.58 | 5.75 | 8.95 | 11.59 |
| SiN | — | 10.57 | 10.42 | 10.91 | 10.89 | 10.63 | 10.94 | 10.33 | 10.10 | 10.49 |
| SiO₂ | 121.27 | 83.27 | 76.55 | 74.99 | 92.04 | 82.60 | 84.19 | 88.18 | 81.71 | 84.04 |

Properties

| | | | | | | | | | | |
|---|---|---|---|---|---|---|---|---|---|---|
| Tv (%) | 81.6 | 87.4 | 39.4% | 39.8% | 29.0% | 59.4% | 58.8% | 58.1% | 48.0% | 40.7% |
| Ta* | 1.7 | −2.4 | −2.4 | −3.5 | −2.5 | −2.5 | −2.7 | −2.5 | −3.9 | −3.7 |
| Tb* | 7.7 | 5.1 | 4.3 | −0.8 | 7.4 | 7.6 | 8.1 | 8.8 | 6.4 | 6.6 |
| Rv(out) | 15.8% | 9.9% | 11.5% | 10.5% | 12.6% | 6.5% | 5.9% | 5.8% | 5.9% | 7.8% |
| (%) | | | | | | | | | | |
| Rv(in) | 16.2% | 10.1% | 18.7% | 17.6% | 28.2% | 12.5% | 16.2% | 16.7% | 19.3% | 21.9% |
| (%) | | | | | | | | | | |
| RL* | 48.5 | 38.1 | 50.0 | 49.2 | 61.6 | 42.6 | 48.0 | 49.2 | 51.9 | 55.0 |
| R65L* | 46.8 | 55.3 | 55.3 | 54.3 | 58.6 | 47.7 | 51.3 | 51.0 | 55.0 | 56.2 |
| Ra* | −8.3 | 5.1 | 4.1 | 7.1 | −1.2 | 2.7 | 1.8 | 0.7 | 2.5 | 1.5 |
| R65a* | 3.2 | 4.7 | 4.2 | 4.4 | 7.9 | 5.7 | 5.3 | 5.9 | 3.8 | 5.3 |
| Rb* | −15.8 | −12.2 | −2.1 | −12.8 | −14.3 | −8.8 | −11.2 | −14.2 | −12.2 | −13.7 |
| R65b* | −10.8 | 7.9 | 16.7 | 12.5 | −4.2 | 10.0 | 8.0 | 4.0 | 8.2 | 5.1 |
| Rp_pol6 | 17 | 15 | 32 | 30 | 39 | 23 | 25 | 26 | 29 | 33 |
| 5 (%) | | | | | | | | | | |
| Rp_pol6 | −5 | −6 | −2 | −1 | −2 | −4 | −4 | −4 | −3 | −2 |
| 5-a | | | | | | | | | | |
| Rp_pol6 | 9 | 1 | 3 | 1 | 4 | 3 | 2 | 1 | −1 | 0 |
| 5-b | | | | | | | | | | |
| R65Y | 21 | 25 | 32 | 31 | 30 | 25 | 27 | 26 | 31 | 31 |
| Rp_pol6 | 15 | 16 | 31 | 30 | 37 | 23 | 26 | 26 | 31 | 34 |
| 5 | | | | | | | | | | |
| (blue)(%) | | | | | | | | | | |
| Rp_pol6 | 17 | 16 | 33 | 31 | 39 | 24 | 26 | 27 | 31 | 34 |
| 5 | | | | | | | | | | |
| (green)(%) | | | | | | | | | | |
| Rp_pol6 | 16 | 13 | 31 | 30 | 39 | 21 | 23 | 24 | 28 | 32 |
| 5 | | | | | | | | | | |
| (red)(%) | | | | | | | | | | |

Examples 1 and 2, provided with a TL>70% are suitable as primary p-polarized light reflective coating for a display area having a TL<30%, but also for the second viewing area where legal requirements may impose a TL>70%.

Examples 3 to 10 can only be provided for use in a display area having TL<30%, where they can provide for Rp_pol reflection of more than 23%, at an angle of incidence of 65°.

These values indicate the suitability of the present glazing unit having at least a first area and a second area, wherein the first area is a display area having a light transmittance <30%, said display area being provided with a primary p-polarized light reflective coating, in a HUD system as presently claimed, for p-polarized light.

### Examples 11 to 13

Examples 11 to 13 were prepared according to the description of the second particularly suitable primary p-polarized light reflective coating, with a layer of absorbent material. Examples 11 and 12 comprise two sequences of high refractive index layer/low refractive index layer, where the third layer comprises several high refractive index sub-layers. Example 13 comprises one sequence of high refractive index layer/low refractive index layer, where the high refractive index layer (third layer) comprises several high refractive index sub-layers.

The assembled glazing unit comprised two sheets of clear glass of 2.1 mm, laminated with a PVB layer of 0.76 mm. The opacifying means may be chosen among any of those discussed above.

Values for the layer thicknesses of the primary p-polarized light reflective coating of Examples 11 to 13 are indicated in Table 3, together with the results of the measured parameters of the glazing unit in absence of opacifying means. Indeed, the presence of the opacifying means does not allow for measurements to be taken properly (due to the lack of light transmission).

The primary p-polarized light reflective coating of Examples 11 to 13 have a light transmittance less than 45%, making them suitable for a display area having a light transmittance <30%. The advantage of the primary p-polarized light reflective coatings of Examples 11 to 13 present on the display area of the present glazing unit is that they allow for reflection of p-polarized light up to more than 25% (Rp-pol), proving useful in a HUD system as presently claimed.

TABLE 3

| | | |
|---|---|---|
| Example 11 | Example 12 | Example 13 |

Material// Thickness (nm)

| | | | |
|---|---|---|---|
| TZO | 15.39 | 11.70 | — |
| MgF₂ | 16.24 | 62.82 | — |
| Nb₂O₅ | 26.36 | 41.31 | 32.34 |
| SiN | 10.00 | 10.20 | 10.82 |
| Absorber | 10.29 | 9.42 | 17.56 |
| SiN | 10.00 | 10.31 | 10.79 |
| SiO₂ | 78.86 | 74.99 | 93.24 |

Properties

| | | | |
|---|---|---|---|
| Tv (%) | 40.2% | 38.8% | 31.0% |
| Ta* | −2.5 | −2.7 | −2.5 |
| Tb* | 2.9 | 2.9 | 6.4 |
| Rv(out) (%) | 12.6% | 10.5% | 12.5% |
| Rv(in) (%) | 17.8% | 17.6% | 29.6% |
| RL* | 49.0 | 48.0 | 61.8 |
| R65L* | 54.3 | 53.3 | 59.8 |
| Ra* | 2.1 | −1.2 | −1.2 |
| R65a* | 2.2 | 5.3 | 5.7 |
| Rb* | −8.8 | −11.2 | −14.2 |
| R65b* | 14.7 | −4.2 | 4.0 |
| Rp_pol65 (%) | 28 | 27 | 38 |
| Rp_pol65-a | −3 | −2 | −4 |
| Rp_pol65-b | 2 | 4 | 4 |
| R65Y | 31 | 30 | 37 |
| Rp_pol65 (blue)(%) | 27 | 26 | 38 |
| Rp_pol65 (green)(%) | 28 | 27 | 39 |
| Rp_pol65 (red)(%) | 27 | 27 | 38 |

1. A glazing unit having at least a first area and a second area, comprising:
an outer pane having a first surface and a second surface; and
an inner pane having a first surface and a second surface,
wherein both panes are bonded by an interlayer providing contact between the first surface of the inner pane and the second surface of the outer pane, and
wherein the first area is a display area having a light transmittance <30%, said display area being provided with a primary p-polarized light reflective coating.

2. The glazing unit according to claim 1, wherein the second area is a viewing area having a light transmittance ≥70%.

3. The glazing unit according to claim 1, wherein the display area has a light transmittance <30% by means of at least one opacifying means selected from the group consisting of a dark print, a dark insert, a dark patch, or combinations thereof.

4. The glazing unit according to claim 3, wherein the dark print is selected from the group consisting of an enamel, a paint, and/or an ink.

5. The glazing unit according to claim 3, wherein the dark insert is selected from the group consisting of a polyvinyl butyral (PVB), an ethylene vinyl acetate (EVA), a polyurethane (PU), a polyethylene terephthalate (PET), a polycarbonate, a polyvinylchloride, a mylar, or a mixture thereof.

6. The glazing unit according to claim 4, wherein when the dark print and/or the dark insert is the opacifying means, the primary p-polarized light reflective coating is present on the second surface of the inner pane.

7. The glazing unit according to claim 3, wherein the dark patch is selected from the group consisting of a glass or a plastic comprising a poly(methyl meth)acrylate (PMMA), a polycarbonate, a polyethyleneterephthalate (PET), a polyolefin, a polyvinyl chloride (PVC), or a mixture thereof.

8. The glazing unit according to claim 7, wherein when the dark patch is the opacifying means, the primary p-polarized light reflective coating is present on a second surface of the patch material.

9. The glazing unit according to claim 1, wherein the primary p-polarized light reflective coating comprises at least one sequence of layers having a high refractive index layer and/or a low refractive index layer.

10. The glazing unit according to claim 9, wherein the high refractive index layer comprises oxides of Zn, Sn, Ti, Nb, Zr, Ni, In, Al, Ce, W, Mo, Sb, Bi and mixtures thereof, nitrides or oxynitrides of Si, Al, Zr, B, Y, Ce, La, and mixtures thereof.

11. The glazing unit according to claim 9, wherein the low refractive index layer is selected from the group consisting of a silicon oxide, a silicon oxycarbide, an aluminum oxide, a mixed silicon aluminum oxide, a mixed silicon zirconium oxide, an aluminum doped zinc oxide, a magnesium fluoride, or a mixture thereof.

12. The glazing unit according to claim 1, wherein the primary p-polarized light reflective coating is a magnetron sputtered coating.

13. The glazing unit according to claim 1, wherein the primary p-polarized light reflective coating comprises, in sequence starting from a substrate surface,
at least one high refractive index layer having a thickness of from 50 to 100 nm; and
at least one low refractive index layer having a thickness of from 70 to 160 nm,
wherein the least one high refractive index layer comprises at least one of an oxide of Zr, Nb, Sn, a mixed oxide of Ti, Zr, Nb, Si, Sb, Sn, Zn, In, a nitride of Si, Zr, and a mixed nitride of Si, Zr.

14. The glazing unit according to claim 1, wherein the primary p-polarized light reflective coating comprises, in sequence starting from the substrate surface,
a first layer, comprising one or more high refractive index sub-layers, the first layer having a thickness of from 1 to 100 nm,
a second layer, comprising one or more low refractive index sub-layers, the second layer having a thickness of from 1 to 220 nm,
a third layer, comprising one or more high refractive index sub-layers, the third layer having a thickness of from 40 to 150 nm, and
a fourth layer, comprising one or more low refractive index sub-layers, the fourth layer having a thickness of from 40 to 200 nm,
wherein the primary p-polarized light reflective coating further comprises at least one first layer of absorbent material,
wherein said at least one first layer of absorbent material has a thickness of from 0.2 to 15 nm, and
wherein said absorbent material has an average refractive index (n) above 1 and an average extinction coefficient (k) above 0.1, with n and k calculated over a value at wavelengths of 450 nm, 550 nm, and 650 nm.

15. The glazing unit according to claim 1, further comprising an infrared reflective coating.

16. The glazing unit according to claim 1, wherein at least the second area is provided with an anti-fingerprint coating and/or an easy to clean coating.

17. The glazing unit according to claim 1, wherein the interlayer is a wedge interlayer.

18. A HUD system, comprising:
the glazing unit according to claim 1, having the at least a first area as a display area having a light transmittance <30% and the second area, and
a light source projecting at least 50% p-polarized light towards the first display area of the glazing unit,
wherein a light projected by the light source is incident on and reflected from said first display area.

19. A HUD system comprising the glazing unit according to claim 1,
wherein the glazing unit comprises the outer pane having the first surface and the second surface and the inner pane having the first surface and the second surface, both panes bonded by an interlayer providing contact between the first surface of the inner pane and the second surface of the outer pane,
wherein the first area is a display area having a light transmittance <30%, said display area being provided with a first p-polarized light reflective coating,
wherein the HUD system further comprises a p-polarized light source, and
wherein the p-polarized light source projects a light at an angle of incidence of 42 to 72° on the display area of the glazing unit to reflect said p-polarized light.

20. The glazing unit according to claim 1, wherein the primary p-polarized light reflective coating comprises, in sequence starting from the substrate surface, at least one
first layer, comprising one or more high refractive index sub-layers, the first layer having a thickness of from 1 to 100 nm:
second layer, comprising one or more low refractive index sub-layers, the second layer having a thickness of from 1 to 220 nm;
third layer, comprising one or more high refractive index sub-layers, the third layer having a thickness of from 40 to 150 nm; and
fourth layer, comprising one or more low refractive index sub-layers, the fourth layer having a thickness of from 40 to 200 nm,
wherein the primary p-polarized light reflective coating further comprises at least one first layer of absorbent material,
wherein said at least one first layer of absorbent material has a thickness of from 0.2 to 15 nm, and
wherein said absorbent material has an average refractive index (n) above I and an average extinction coefficient (k) above 0.1, with n and k calculated over a value at wavelengths of 450 nm. 550 nm, and 650 nm.
